(19) United States
(12) Patent Application Publication
(10) Pub. No.: US 2020/0053849 A1
(43) Pub. Date: Feb. 13, 2020

(54) PROGRAMMABLE DRIVER FOR VARIABLE LIGHT INTENSITY

(71) Applicant: ABL IP Holding LLC, Atlanta, GA (US)

(72) Inventors: Towfiq M. Chowdhury, Lake Forest, IL (US); Feng Chen, Hoffman Estates, IL (US)

(21) Appl. No.: 16/059,606

(22) Filed: Aug. 9, 2018

(51) Int. Cl. H05B 33/08; H05B 37/02

(52) U.S. Cl. CPC H05B 33/0845; H05B 37/0209

(57) ABSTRACT

Certain aspects involve lighting systems in which an intensity can be selectively modified. For instance, a lighting system includes a light source and a programmable device. The programmable device is configured to detect an input resistance and cause a particular current to flow through the light source, thereby causing the light source to emit a particular lumen intensity corresponding to an input resistance.

### TECHNICAL FIELD

This disclosure relates generally to lighting systems having multiple groups of light-emitting diodes that can produce illumination of different intensities.

### BACKGROUND

Lighting systems include light-emitting diodes (“LEDs”) that provide high-quality lighting despite a compact size. Different light-emitting diodes and groups of light-emitting diodes can have different intensities. Thus, lighting fixtures, such as luminaires, are often manufactured in different configurations that provide different intensities that a customer can choose. But stocking LED-based fixtures to accommodate various desirable intensities can require maintaining a relatively large or cumbersome inventory.

### SUMMARY

Certain aspects involve lighting systems in which the intensity of the illumination can be selectively modified. For instance, a lighting system includes a light source and a programmable device. The programmable device is configured to detect an input resistance, for example, caused by a combination of a switch and a resistor, and to cause a particular current to flow through the light source, thereby causing the light source to emit a particular lumen intensity corresponding to the input resistance.

These illustrative aspects are mentioned not to limit or define the disclosure, but to provide examples to aid understanding thereof. Additional aspects are discussed in the Detailed Description, and further description is provided there.

### BRIEF DESCRIPTION OF THE DRAWINGS

Features, aspects, and advantages of the present disclosure are better understood when the following Detailed Description is read with reference to the accompanying drawings.

FIG. 1 depicts an example of a lighting system in which different light sources can be adjusted to produce illumination having different intensity levels, according to certain aspects of the present disclosure.

FIG. 2 depicts an example of an implementation of the lighting system from FIG. 1 in which light sources are selectively activated or bypassed to adjust the intensity of the lighting system, according to certain aspects of the present disclosure.

FIG. 3 depicts the lighting system of FIG. 1 in which switches can be used to control a resistance presented to an input of a driver that controls an intensity level, according to certain aspects of the present disclosure.

FIG. 4 depicts the lighting system of FIG. 1 in which an additional configuration of switches can be used to control a resistance presented to an input of a driver that controls an intensity level, according to certain aspects of the present disclosure.

FIG. 5 depicts the lighting system of FIG. 1 in which switches can be used to control a resistance presented to an input to a current regulator that controls an intensity level, according to certain aspects of the present disclosure.

FIG. 6 depicts an example of a method for manufacturing one or more lighting systems in which different LED groups can be selectively activated to produce illumination having different intensities.

### DETAILED DESCRIPTION

Aspects described herein involve lighting system that can operate at different intensities. For example, certain aspects involve lighting systems that include one or more light sources (e.g., LED groups). The light sources can be selectively activated, deactivated, or dimmed to configure the lighting system to output a particular level of light intensity.

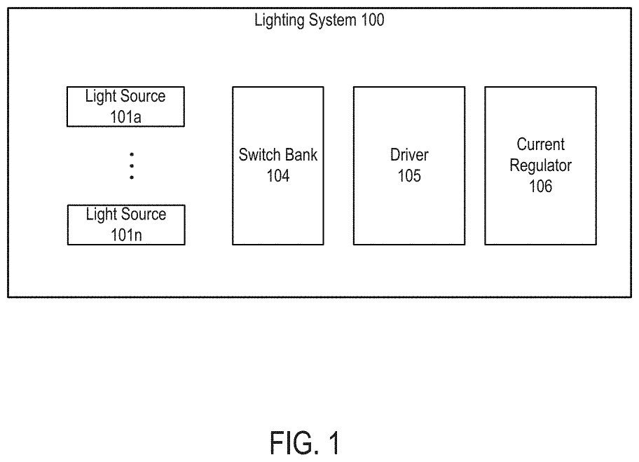

Referring now to the drawings, FIG. 1 depicts an example of a lighting system in which different light sources can be adjusted to produce illumination having different intensity levels, according to certain aspects of the present disclosure. The lighting system 100 can include one or more light sources 101a-n, switch bank 104, driver 105, or current regulator 106.

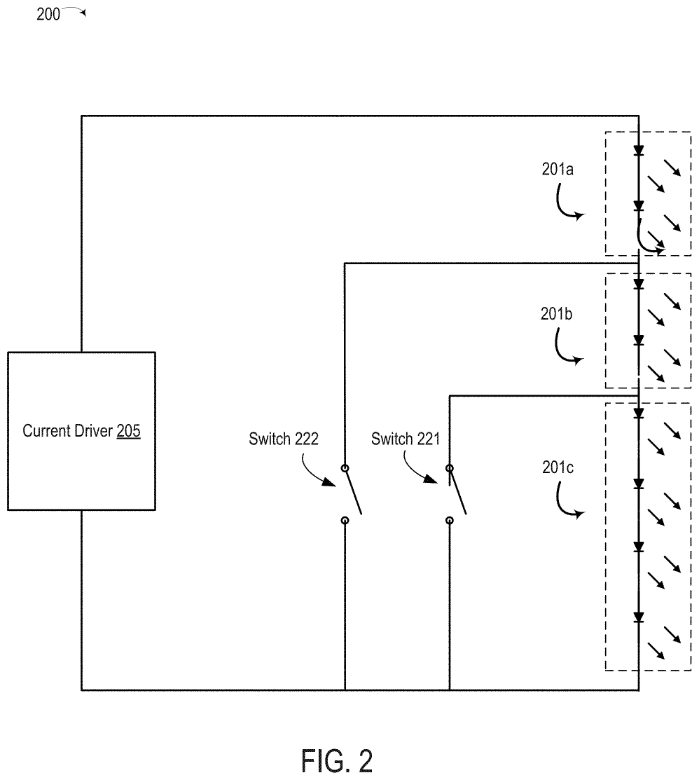

A light source can include any device that can emit light. For illustrative purposes, certain examples described herein with respect to FIGS. 2-5 involve light sources. But other implementations are possible, such as the use of LED groups. Examples of a light source can include one or more LEDs, one or more halogen lighting devices, one or more incandescent lighting devices, one or more laser diodes, one or more organic light emitting diodes, and other light-emitting devices. The particular examples of light sources depicted and/or described herein with respect to FIGS. 2-5 can be replaced with one or more other light sources without departing from the scope of this disclosure.

A light source can emit light at a specific color temperature such as 2700 Kelvin or 3000 Kelvin. In aspects that use more than one light source, each light source can emit light at an identical color temperature, or within a tolerance range of a color temperature. For example, a tolerance range could be +/−100 Kelvin. A first light source emits light at 2660 Kelvin whereas a second light source emits light at 2750 Kelvin, both color temperatures within the tolerance.

Each light source 101a-n can include one or more LEDs in any configuration, such as a series or parallel connection. Switch bank 104 can configure lighting system 100 canemit light of different intensities by using different methods. Examples of these methods include switching different light sources on or off, or selectively dimming an light source to a particular intensity level, etc.

Switch bank 104 can include one or more switches. As used herein, a “switching device,” or a “switch,” can include any mechanism, device, or group of devices that can have different configurations that change one or more connections in one or more electrical circuits of a lighting system. For illustrative purposes, certain examples described herein with respect to FIGS. 2-5 involve switches with one or more throws and poles, slide switches, transistors, etc. But any suitable implementation involving a mechanism, device, or group of devices that change one or more connections in one or more electrical circuits of a lighting system can be used. The particular examples of switching devices depicted and/or described herein with respect to FIGS. 2-5 can be replaced with one or more other switching devices without departing from the scope of this disclosure. Examples of switching devices include DIP switches, slider switches, factory-configured switches, toggles, rotary dials, transistor-based switches, circuit-based switches, etc. Additional examples of switching devices include variable resistors, potentiometers, and the like. For example, a potentiometer can output multiple resistance values, thereby replacing a combination of a switch and a resistor.

In a first example, switch bank 104 configures lighting system 100 to activate a particular number of light sources according to a specified intensity. Light sources 101a and 101b can each emit light at 1000 lumens. Different selections of switches in switch bank 104 cause different configurations. For instance, a first configuration could include an activation of light source 101a, causing an output intensity of 1000 lumens of light. A second configuration could include an activation of both light sources 101a and 101b, causing an output intensity of 2000 lumens. In a variation, if 1000 lumen is required, then lighting system 100 can randomly select light source 101a or 101b in order to minimize wear on a particular light source.

In a second example, light source 101a can be configured, via switch bank 104, to output light at a first intensity and light source 101b can output light at a second intensity. For example, activating light source 101a causes 500 lumens of light, activating light source 101b causes 1000 lumens of light, and activating both light source 101a and 101b causes 1500 lumens of light. Such a configuration permits multiple different levels of intensity to be configured.

In a third example, switch bank 104 configures one or more light sources 101a-n to lower the intensity of the emitted light to a specified level. For example, light source 101a can emit up to 1000 lumens of light, but the activation of a switch in switch bank 104 causes light source to emit only 500 lumens of light. In this manner, adjustable light intensity can be accomplished without multiple light sources.

In each of the above examples, light sources 101a-n can be further dimmed using an external dimming input. Examples of external dimming inputs are dimming switches, dimming dials, or smart home systems. A dimming input can include lowering an input voltage to the lighting system.

For illustrative purposes, certain examples described herein with respect to FIGS. 2-5 use specific lumen intensity levels such as “500 lumen.” Such intensity levels are for illustrative purposes only. Other lumen values are possible. The particular examples of lumen intensities depicted and/or described herein with respect to FIGS. 2-5 can be replaced with other lumen intensity values without departing from the scope of this disclosure.

Switch bank 104 can include any device having one or more switches or switching devices that provides one or more signals, that vary an input resistance of driver 105 or current regulator 106, or some combination thereof.

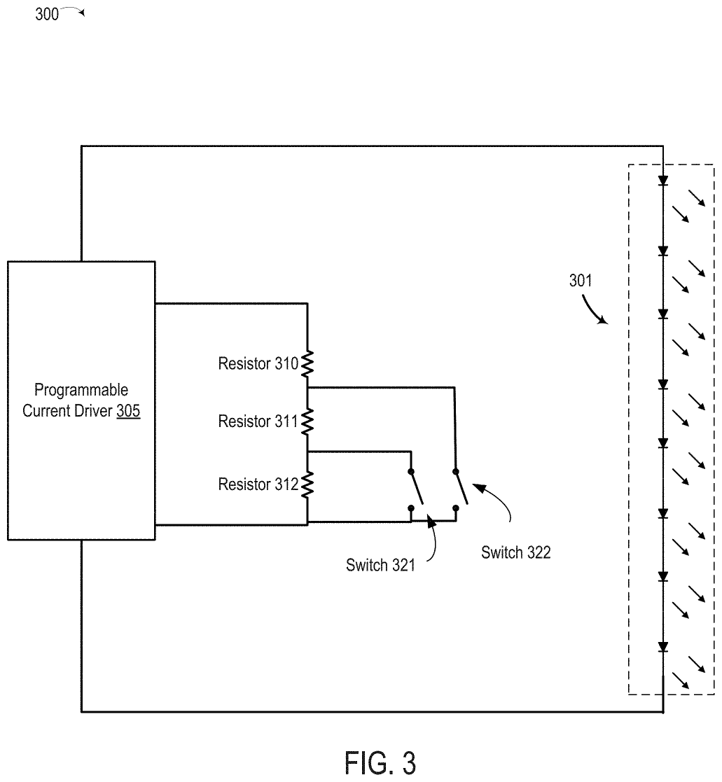

Lighting system 100 can include a driver 105 or a current regulator 106. Driver 105 can provide a regulated voltage for the light sources. Driver 105 can be a voltage driver that emits a constant voltage, a current driver that emits a constant current, or a programmable version thereof. For example, as explained further with respect to FIG. 3, different programmed current levels (corresponding to particular intensities) of driver 105 can be activated by various combinations of resistors and switches.

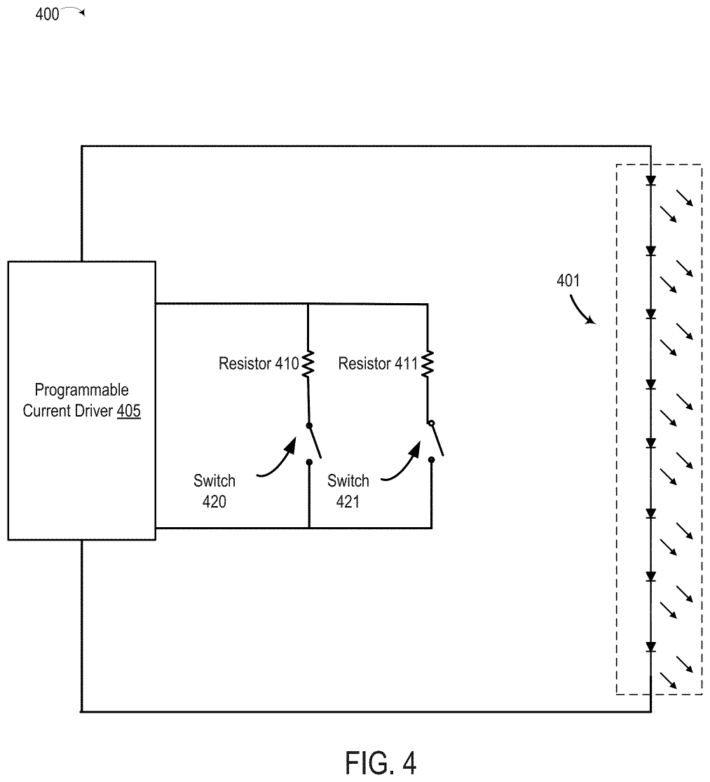

Current regulator 106 can regulate a current that is provided to the light sources. Different current levels can be selected. For example, as explained further with respect to FIG. 4, different programmed current levels (corresponding to particular intensities) of current regulator 106 can be activated by various combinations of resistors and switches.

Driver 105, optionally in conjunction with current regulator 106, can cause the intensity of the light to be adjusted either by dimming one or more light sources 101 a-n or selectively activating or deactivating one or more light sources 101a-n. For example, driver 105 could receive an input voltage from a power source and step the voltage down as appropriate for the light sources.

In some aspects, configuring an intensity of light sources in a lighting system can reduce costs or other resource expenditures for manufacturing multiple lighting systems with different non-configurable intensity levels. In a simplified example, if a lighting system with a target lumen output of 500-lumens is desirable, a luminaire with two 500-lumen light sources can activate only one of the light sources, which reduces manufacturing expenditures as compared to a luminaire that has a fixed output 1000-lumen light source and a fixed output 500-lumen light source.

FIG. 2 depicts an example of an implementation of the lighting system from FIG. 1 in which light sources are selectively activated or bypassed to adjust the intensity of the lighting system, according to certain aspects of the present disclosure. In FIG. 2, the lighting system 200, which is an example of implementing the lighting system 100, includes current driver 205, switch 221, switch 222, and LED groups 201a-c. Each LED group 201a-c can have the same or a different number of LEDs. As depicted, LED groups 201a and 201b include two LEDs, whereas LED group 201c has four LEDs. LED group 201c could emit double the brightness of either LED group 201a or LED group 201b.

As shown in Table 1 below, based on the configuration of switches 221 and 222, the LED groups 201b and 201c can be activated or deactivated, resulting in configurable intensity levels of low, medium, and high. The terms low, medium, and high are relative. A low intensity is less than a medium intensity and a high intensity. A medium intensity is greater than a low intensity but less than a high intensity. Low, medium, and high intensities can be different lumen values. For example, a low intensity could be 500 lumen, a medium intensity 1000 lumen, and a high intensity 2000 lumen.

Current driver 205 provides an appropriate voltage to LED groups 201a, 201b, and 201c. In one example, switch 222 is closed, thereby shorting LED groups 201b-c. Closing switch 222 can cause current to cease flowing through LED groups 201b and 201c. This cessation of current flow can cause a low intensity of light to be emitted from lighting system 200. In this case, only LED group 201a is activated. A low intensity is lower than the other configurations, medium and high. For example a low intensity could be 500 lumen. If switch 222 is closed, then closing switch 221 does not change the intensity because LED groups 201b and 201c are deactivated because current is not flowing through LED groups 201b and 201c.

TABLE 1

| Switch 221 | Switch 222 | Lumen Output |
|---|---|---|
| OPEN | OPEN | HIGH |
| CLOSED | OPEN | MEDIUM |
| OPEN | CLOSED | LOW |
| CLOSE | CLOSED | LOW |

Opening switches 221 and 222 switch 221 causes a high intensity of light to be emitted. In this configuration, LED groups 201a-c are activated. Opening switch 222 and closing switch 221 causes only LED groups 201a and 201b to be activated, which is a medium level of light.

Although FIG. 2 and Table 1 depict two configuration switches 221 and 222, fewer or a greater number of configuration switches are possible, resulting in a different number of possible intensity levels. Each additional switch can short a path around one or more LED groups, causing the LED groups to deactivate.

In a simplified example, a professional installer, store clerk, manufacturing system, technician, or user can configure switches 221 and 222 such that the current driver 205 causes LED groups 201a-c to be activated and a particular intensity level is outputted by the lighting system 200. For example, a professional installer may configure lighting system 200 to operate with a particular intensity (e.g., 2000 lumen), then install the lighting system in a customer's premises. Similarly, a professional installer may configure another lighting system 200 with a higher intensity (e.g., 4000 lumen) of light and install the lighting system in the customer's basement, where more light is desired.

FIG. 3 depicts a lighting system 300 in which switches can be used to control a resistance presented to an input of a driver that controls an intensity level, according to certain aspects of the present disclosure. In FIG. 3, the lighting system 300, which is an example of implementing the lighting system 100, includes programmable current driver 305, resistors 310-312, switch 321, switch 322, and LED group 301.

Programmable current driver 305 is configurable by switch 321 and switch 322. More specifically, different configurations of resistors 310-312, switch 321, and switch 322 cause different combinations of resistance to be presented to programmable current driver 305. Presenting different combinations of resistance can cause programmable current driver 305 to adjust the output current according to a particular resistance. The resistance presented to programmable current driver 305, as configured by resistors 310-312, switch 321, and switch 322, can be referred to as the Rset value. For example, the Rset value of 1 kOhm can cause the driver to allow 500 mA to flow through a LED group. A current of 500 mA flowing through LED group 301 causes LED group 301 to emit light of a particular intensity.

As depicted in Table 2, the combination of switch 321 and 322 results in three different configurations of intensity: low, medium, and high. Opening a particular switch can cause a current flow through a resistor that is in parallel with the switch. Conversely, closing a particular switch can cause a current path through one or more resistors to be shorted, thereby altering the current flow through the light source.

TABLE 2

| Switch 321 | Switch 322 | Lumen Package |
|---|---|---|
| OPEN | OPEN | HIGH |
| CLOSED | OPEN | MEDIUM |
| OPEN | CLOSED | LOW |
| CLOSED | CLOSED | LOW |

In a first configuration, switches 321 and 322 being open can cause a resistance to be seen by programmable current driver 305 that is the sum of the resistance values of resistors 310, 311, and 312. The programmable current driver 305 can output an amount of current that causes LED group 301 to output a high lumen output.

In a second configuration, switch 321 being closed and switch 322 being open can cause a resistance to be seen by programmable current driver 305 that is the sum of the resistance values of resistors 310 and 311. The programmable current driver 305 can output an amount of current necessary to cause LED group 301 to output a medium lumen output.

In a third configuration, switch 321 being open and switch 322 being closed can cause a resistance to be seen by programmable current driver 305 that is the resistance value of resistor 310. The programmable current driver 305 outputs an amount of current necessary to cause LED group 301 to output a low lumen output. An identical low lumen output is obtained when switch 321 is closed and switch 322 is closed, as closing switch 321 does not change the resistance if switch 322 is closed.

FIG. 4 depicts the lighting system of FIG. 1 in which an additional configuration of switches can be used to control a resistance presented to an input of a driver that controls an intensity level, according to certain aspects of the present disclosure. In FIG. 4, the lighting system 400, which is an example of implementing the lighting system 100, includes programmable current driver 405, resistor 410, resistor 411, switch 420, switch 421, and LED group 401. As depicted, a combination of switch 420 and resistor 410 is in parallel with a combination of switch 412 and resistor 411. But other configurations are possible.

Programmable current driver 405 is configurable by switches 420-421. More specifically, different configurations of resistors 410-411 and switches 420-421 cause different combinations of resistance to be presented to programmable current driver 405. Presenting different combinations of resistance can cause programmable current driver 405 to adjust the output current according to a particular resistance. The resistance presented to programmable current driver 405, as configured by resistors 410-411 and switches 420-421, can be referred to as the Rset value. For example, the Rset value of 1 kOhm can cause the driver to allow 500 mA to flow through a LED group. A current of 500 mA flowing through LED group 401 causes LED group 401 to emit light of a particular intensity.

As depicted in Table 3, the combination of switches 420-421 results in four different configurations of intensity: very low, low, medium, and high. Opening a particular switch can cause a current flow through a different path. Conversely, closing a particular switch can cause a current path through one or more resistors to be completed, causing the programmable device to be presented with a resistance equal to the particular resistor.

TABLE 3

| Switch 420 | Switch 421 | Lumen Package |
|---|---|---|
| OPEN | OPEN | HIGH |
| CLOSED | OPEN | MEDIUM |
| OPEN | CLOSED | LOW |
| CLOSED | CLOSED | VERY LOW |

In a first configuration, switches 420 and 421 being open can cause an extremely high, or infinite, resistance to be seen by programmable current driver 405. As a result, the programmable current driver 405 can output an amount of current that causes LED group 401 to output a high lumen output.

In a second configuration, switch 420 being closed and switch 421 being open can cause a resistance to be seen by programmable current driver 405 that is equal the resistance value of resistor 410. The programmable current driver 405 can output an amount of current necessary to cause LED group 401 to output a medium lumen output.

In a third configuration, switch 420 being open and switch 421 being closed can cause a resistance to be seen by programmable current driver 405 that is the resistance value of resistor 411. The programmable current driver 405 outputs an amount of current necessary to cause LED group 401 to output a low lumen output.

In a fourth configuration, both switches 420 and 421 being closed causes a resistance to be seen by programmable current driver 405 that is equal to a parallel combination of resistors 410 and 411. In response, the programmable current driver outputs an amount of current necessary to cause LED group 401 to cause a very low lumen output.

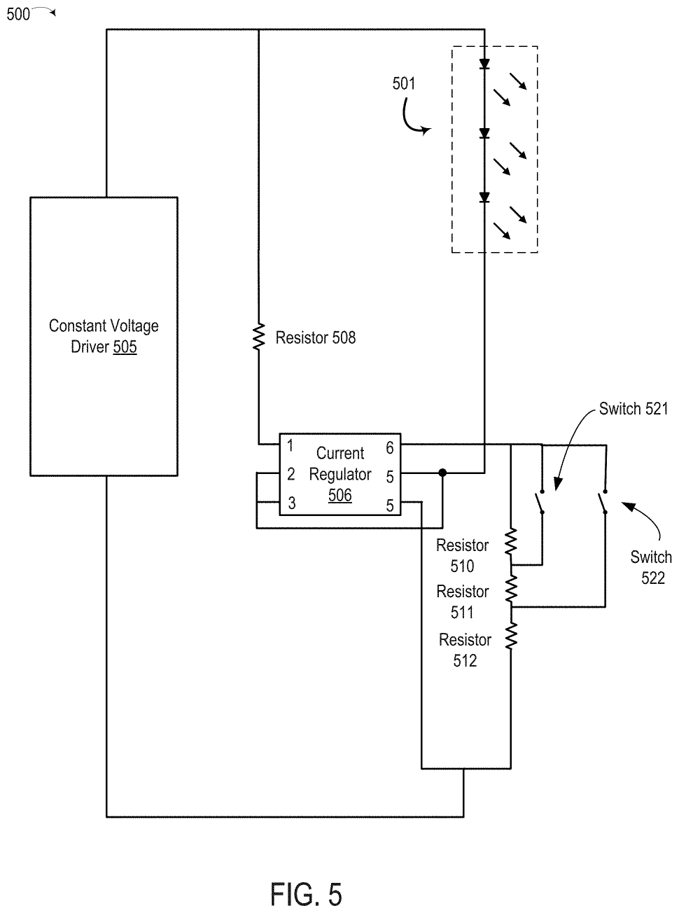

FIG. 5 depicts a lighting system 500 in which switches can be used to control a resistance presented to an input to a current regulator that controls an intensity level, according to certain aspects of the present disclosure. In FIG. 5, the lighting system 500, which an example of implementing the lighting system 100, includes constant voltage driver 505, resistor 508, current regulator 506, resistors 511-513, switch 521, switch 522, and LED group 501.

Constant voltage driver 505 provides a constant output voltage suitable for LED group 501. Examples of suitable voltages are 5 Volts or 12 Volts. Current regulator 506 provides an appropriate amount of current for a lumen intensity level specified configured by switches 521 and 522 in conjunction with resistors 511-513.

Current regulator 506 provides a configurable current. As depicted, current regulator 506 has six inputs (labeled 1-6). Input 1 connects to the constant voltage driver 505 via resistor 508. Input 5 connects to another output from constant voltage driver 505. As depicted, inputs 2, 3, and 5 are each connected to the cathode-size of LED group 501. Inputs 5 and 6 receive a particular resistance as determined by resistors 511-513 and switches 521 and 522.

As depicted in Table 4, the combination of switch 521 and 522 results in three different configurations of intensity. In a first configuration, switch 521 being open and switch 522 being open causes a resistance to be seen by current regulator 506 that is the sum of the resistance values of resistors 510, 511, and 512. The current regulator 506 outputs an amount of current necessary to cause LED group 501 to output a low lumen output.

TABLE 4

| Switch 521 | Switch 522 | Lumen Package |
|---|---|---|
| OPEN | OPEN | LOW |
| CLOSED | OPEN | MEDIUM |
| OPEN | CLOSED | HIGH |
| CLOSED | CLOSED | HIGH |

In a second configuration, switch 521 being closed and switch 522 being open causes a resistance to be seen by current regulator 506 that is the sum of the resistance values of resistors 511 and 512. The current regulator 506 outputs an amount of current necessary to cause LED group 501 to output a medium lumen output.

In a third configuration. switch 521 being open and switch 522 being closed causes a resistance to be seen by current regulator 506 that is the resistance value of resistor 512. The current regulator 506 outputs an amount of current necessary to cause LED group 501 to output a high lumen output. An identical low lumen output is obtained when switch 521 is closed and switch 522 is closed, as closing switch 521 does not change the resistance if switch 522 is closed.

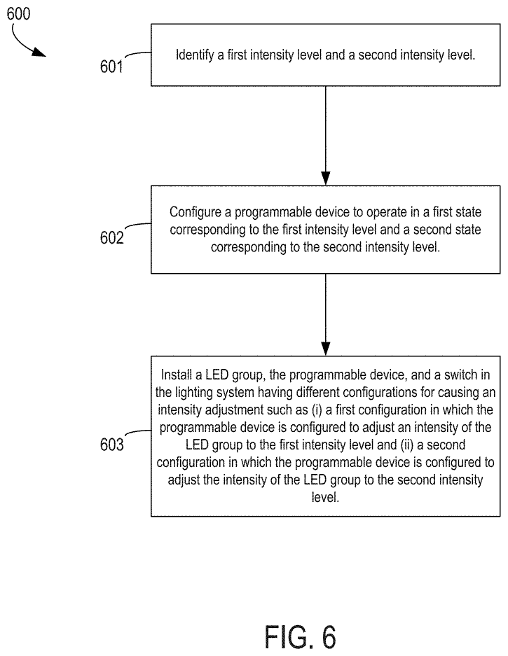

FIG. 6 depicts an example of a method for manufacturing one or more lighting systems in which different LED groups can be selectively activated to produce illumination having different intensities. Method 600 can be used to manufacture one or more of the lighting systems 100, 200, 300, 400, as well as variants thereof. For illustrative purposes, the method 600 is described with respect to the examples depicted in FIGS. 1-4. But other implementations are possible.

At block 601, method 600 involves identifying a first intensity level and a second intensity level. In some aspects, identifying these values can involve accessing these values from files. In one example, a computing device executing suitable design software can access specification data from one or more files stored in a non-transitory computer-readable medium. In another example, a technician, can access specification data from one or more files. The files can include specifications for a luminaire or other lighting system. The specification data can include, for example, one or more dimming curves. The specification data can include additional parameters such as different target lumen outputs. In some aspects, the specification data can include a threshold tolerance with respect to the dimming curves. The computing device can identify the target lumen outputs from the specification data. In some aspects, a technician can perform one or more of these operations.

At block 602, method 600 involves configuring a programmable device to operate in a first state corresponding to the first intensity level and a second state corresponding to the second intensity level. A programmable device can include a voltage regulator, current regulator, voltage driver, current driver, or any other device that can alter current or voltage to a predefined level.

For example, the computing device can access the schematic diagram that includes a particular configuration of switches necessary for a particular lumen output or LED group configuration, such as those depicted Tables 1-4. From the configuration, the computing device can configure a set of switches, or make the appropriate connections such that the driver is appropriately configured.

At block 603, method 600 involves installing a LED group, the driver, and a switch in the lighting system having different configurations for causing an intensity adjustment to different intensity levels. For instance, the driver can adjust an intensity of the LED group to the first intensity level in a first configuration and adjust the intensity of the LED group to the second intensity level in a second configuration. The driver can be a voltage driver, a current driver, or a programmable version thereof. In some aspects, the computing device can output a schematic diagram or other data that includes circuits (e.g., one or more of the circuits depicted in FIGS. 1-4) that include one or more LED groups, a switch bank, a driver, or a current regulator.

In some aspects, the outputted schematic diagram or other data can be provided (e.g., by the computing device or via a transfer on a non-transitory computer-readable medium) to one or more manufacturing systems. A manufacturing system assemble one or more LED groups, a switch bank, a microcontroller, and associated circuitry into the lighting system. For example, the manufacturing system can position one or more of the LED groups, position one or more switches, position a current driver, and connect the LED groups, switches, and current driver to a wiring system (e.g., a printed circuit board or other set of conductors) that implements the outputted schematic diagram or other data.

In additional or alternative aspects, the outputted schematic diagram or other data can be provided (e.g., by the computing device or via a transfer on a non-transitory computer-readable medium) to one or more technicians. The technician can manually assemble the LED groups, the switch bank, and the current driver into the lighting system. For instance, the technician can position one or more of the LED groups, position one or more switches, position the current driver, and connect the LED groups and switches to a wiring system that implements the outputted schematic diagram or other data.

In some aspects, installing the LED groups with the switch involves implementing lighting system 200, 300, 400, or 500. For instance, a manufacturing system or technician could position one or more switches between the first LED group and the second LED group in a first path that includes a current driver. A manufacturing system or technician could also position one or more switches between the first LED group and a third LED group in a second path that includes the current driver. The switch could be a slide switch, as described above with respect to FIGS. 2-5. The slide switch could have a first position that implements the first configuration and a second position that implements the second configuration.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “computing,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing description, including illustrated examples, has been presented only for the purpose of illustration and description and is not intended to be exhaustive or to limit the invention to the precise forms disclosed. Numerous modifications, adaptations, and uses thereof will be apparent to those skilled in the art without departing from the scope of this disclosure. Aspects and features from each example disclosed can be combined with any other example.

1. A lighting system comprising:
a light source;
a programmable device configured to (i) detect an input resistance and (ii) cause a particular current to flow through the light source, thereby causing the light source to emit a particular lumen intensity corresponding to the input resistance;
a switch configured to receive a selection of an intensity level; and
a resistor connected in parallel or in series with the switch, wherein
a first combination of the switch and the resistor causes a first input resistance and configures the programmable device to provide a first current to the light source, thereby causing the light source to emit light at a first intensity level, and
a second combination of the switch and the resistor causes a second input resistance and configures the programmable device to provide a second current to the light source, thereby causing the light source to emit light a second intensity level.

2. (canceled)

3. The lighting system of claim 1, wherein the light source is configured to emit light of a first color temperature at the first intensity level and light of a second color temperature at the second intensity level, wherein the first color temperature and the second color temperature are within a tolerance range.

4. (canceled)

5. The lighting system of claim 1, wherein the first input resistance equals a resistance value of the resistor and the second input resistance equals a resistance of a parallel combination of the switch in a closed position with the resistor.

6. (canceled)

7. The lighting system of claim 1, wherein the light source is dimmable by a reduction in input voltage to the lighting system.

8. The lighting system of claim 1, wherein the switch comprises a slide switch movable between a first position and a second position, wherein the switch being in the first position causes the first input resistance, and wherein the switch being in the second position causes the second input resistance.

9. The lighting system of claim 1, further comprising an additional switch connected in parallel with a combination of an additional resistor connected in series with the resistor, wherein the additional switch is further configured to operate in conjunction with the additional resistor to provide a third input resistance that configures the programmable device to provide a third current to the light source corresponding to a third intensity level.

10. The lighting system of claim 1, wherein the programmable device is a current driver.

11. The lighting system of claim 1, wherein the programmable device is a current regulator.

12. The lighting system of claim 11, further comprising a voltage driver configured to provide a constant voltage, wherein the current regulator adjusts a current drawn from the voltage driver.

13. A programmable device configured to:
detect one or more of (i) a first resistance indicating a selection of a first intensity from a predefined set of intensities and (ii) a second resistance indicating a selection of a second intensity from the predefined set of intensities, wherein the first resistance is generated by a parallel or series combination of an open switching device and a resistor and the second resistance is generated by a different parallel combination or a different series combination of a closed switching device and the resistor; and
cause one or more of (i) a first current corresponding to the first resistance to flow through a light source, thereby causing the light source to emit light at a first intensity level and (ii) a second current corresponding to a second resistance to flow through the light source, thereby causing the light source to emit light at a second intensity level.

14. (canceled)

15. A method of manufacturing a lighting system, the method comprising:
identifying a first intensity level and a second intensity level;
configuring a switch and a resistor such that a first combination of the switch and the resistor is configured to cause a first input resistance and a second combination of the switch and the resistor is configured to cause a second input resistance;
configuring a programmable device to operate in a first state corresponding to the first intensity level and a second state corresponding to the second intensity level; and
installing a light source, the programmable device, the resistor, and the switch in the lighting system, the lighting system having (i) a first configuration in which the programmable device is configured to adjust an intensity of the light source to the first intensity level, the first configuration caused by the first combination and (ii) a second configuration in which the programmable device is configured to adjust the intensity of the light source to the second intensity level, the second configuration caused by the second combination.

16. (canceled)

17. The method of claim 15, wherein the programmable device is a current driver and wherein the switch is a slide switch having a first position that implements the first configuration and having a second position that implements the second configuration.

18. The method of claim 15, wherein the programmable device is voltage regulator.

19. The method of claim 15, wherein the programmable device is a current regulator and wherein the switch is a slide switch having a first position that implements the first configuration and having a second position that implements the second configuration.

20. (canceled)

21. The programmable device of claim 13, wherein the programmable device is configured to cause the light source emit light of a first color temperature at the first intensity level and light of a second color temperature at the second intensity level.

22. The programmable device of claim 21, wherein the first color temperature and the second color temperature are within a tolerance range.

23. The programmable device of claim 13, wherein the programmable device comprises a current regulator.

24. The programmable device of claim 13, wherein the programmable device comprises a voltage driver.
